(19) United States
(12) Patent Application Publication
(10) Pub. No.: US 2021/0347959 A1
(43) Pub. Date: Nov. 11, 2021

(54) FLAME-RETARDANT THREE-DIMENSION-MOLDED OBJECT AND MANUFACTURING METHOD THEREOF

(71) Applicant: Teco Image Systems Co., Ltd., Taipei City (TW)

(72) Inventors: Teng-Yuan Ou, Taipei City (TW); Ting-Chun Chen, Taipei City (TW)

(21) Appl. No.: 16/875,627

(22) Filed: May 15, 2020

(30) Foreign Application Priority Data
May 8, 2020 (TW) 109115335

(51) Int. Cl. C08J 9/40; B33Y 80/00

(52) U.S. Cl. CPC C08J 9/40; C08J 2377/00; B33Y 80/00

(57) ABSTRACT

A flame-retardant three-dimension-molded object and a manufacturing method thereof are disclosed. The manufacturing method includes steps of: (a) providing a molded body including plural first pores and plural second pores, wherein the plural first pores communicate inward from an outer surface of the molded body, the first pores and the second pores are partially connected to each other, and a first average pore width of the first pores is greater than a second average pore width of the second pores; (b) immersing the molded body in a flame-retardant solution composed of a flame retardant and a solvent for an immersion time under a negative pressure, so that the flame-retardant solution is introduced into the plural first pores and the plural of second pores; and (c) removing the solvent contained in the plurality of first pores and the plurality of second pores, so as to obtain the flame-retardant three-dimensional-molded object.

### FIELD OF THE INVENTION

The present disclosure relates to a three-dimension-molded object, and more particularly to a flame-retardant three-dimension-molded object and a manufacturing method thereof.

### BACKGROUND OF THE INVENTION

With the development of additive manufacturing technology in recent years, the printing speed has been greatly improved, so that the additive manufacturing has achieved industrial production and applied to general products. However, due to the restrictions of the three-dimensional molding process and the types of raw materials, it has not been possible to completely replace the mold products or achieve the goal of mass production. Especially in the flame-retardant products, it is more difficult for three-dimensional molded objects to break through the restrictions of raw materials. The conventional three-dimensional molded objects on the market only meets UL94-HB Flammability Standard (i.e. Standard for Safety of Flammability of Plastic Materials), and most of them cannot achieve UL94-V0 and UL94-5VA. If flame-resistant materials are utilized in three-dimension molding to improve the property of flame resistance, the material costs are expensive, the manufacturing costs are increased, and the competitiveness of products cannot be improved.

Therefore, there is a need of providing a flame-retardant three-dimension-molded object and a manufacturing method thereof, to address the above-mentioned issues.

### SUMMARY OF THE INVENTION

An object of the present disclosure is to provide a flame-retardant three-dimension-molded object and a manufacturing method thereof. By using the additive manufacturing technology such as the powder bed fusion (PB F) technology to stack raw materials and obtain a specific porous pattern, a molded body is formed and has a porosity including a plurality of first pores having a first average pore width and a plurality of second pores having a second average pore width. The molded body includes a sufficient specific surface area, and it benefits that a flame retardant is disposed within the pores of the molded body evenly in the subsequent process, for example being immersed in a flame-retardant solution. Thus, the flame-retardant three-dimension-molded object is obtained. The first average pore width of the plurality of first pores and the second average pore width of the plurality of second pores are controlled by adjusting the size of raw materials, the sintering energy and the process parameters, and also controlled by the structural design. It is helpful of increasing the efficiency of introducing the flame retardant into the three-dimensional molded object, and helpful of simplifying the manufacturing process. Consequently, the flame retardancy of three-dimensional molded object is improved.

Another object of the present disclosure is to provide a flame-retardant three-dimension-molded object and a manufacturing method thereof. While the size of the giant pores in the three-dimensional molded object is controlled by the structural design and the size of the medium pores in the three-dimensional molded object is controlled by the process parameters of the additive manufacturing technology, the three-dimensional molded object is formed and includes the giant pores and medium pores. It facilitates the flame retardant in form of a liquid to be introduced into the pores. The flame retardant is evenly distributed in the interior of the three-dimensional molded objects, to achieve the manufacturing of the flame-retardant three-dimensional molded object. The structure of giant pores is helpful of introducing the flame retardant into the pores, and the structure of medium pores is helpful of uniforming the distribution of the flame retardant. Thus, the flame-retardant three-dimensional molded object of the present disclosure realizes an optimized process.

A further object of the present disclosure is to provide a flame-retardant three-dimension-molded object and a manufacturing method thereof. Since the flame retardant is added into the molded body after the three-dimension molding process, it prevents the flame retardant from influencing the dimensional accuracy variation or the structural processing. Moreover, it is conducive to the raw material recovery and reprocessing of the three-dimensional molded object.

In accordance with an aspect of the present disclosure, there is provided a manufacturing method for a flame-retardant three-dimension-molded object. The manufacturing method includes steps of: (a) providing a molded body including a plurality of first pores and a plurality of second pores, wherein the plurality of first pores are in fluid communication from at least one outer surface of the molded body, the plurality of first pores and the plurality of second pores are at least partially in fluid communication with each other, the plurality of first pores includes a first average pore width, the plurality of second pores includes a second average pore width, and the first average pore width is greater than the second average pore width; (b) immersing the molded body in a flame-retardant solution for an immersion time under a negative pressure, so that the flame-retardant solution is introduced into the plurality of first pores and the plurality of second pores, wherein the flame-retardant solution includes a flame retardant and a solvent; and (c) removing the solvent contained in the plurality of first pores and the plurality of second pores, so as to obtain the flame-retardant three-dimensional-molded object.

In an embodiment, the first average pore width is ranged from 50 microns to 100 microns, and the second average pore width is ranged from 2 microns to 50 microns.

In an embodiment, the molded body is produced by a powder bed fusion technology.

In an embodiment, the plurality of first pores includes an inner surface, the plurality of second pores includes an inner surface, and a total area of the inner surface of the plurality of second pores is greater than that of the inner surface of the plurality of first pores.

In an embodiment, the molded body is formed by a polyamide 12 powder, and the polyamide 12 power includes an average particle size ranged from 10 microns to 70 microns.

In an embodiment, the molded body includes a specific surface area ranged from 0.2 m²/g to 1.0 m²/g. In an embodiment, the negative pressure is greater than 50 kilopascals and, the immersion time is ranged from one minute to ten minutes.

In accordance with an aspect of the present disclosure, there is provided a flame-retardant three-dimension-molded object. The flame-retardant three-dimension-molded object includes a molded body and a flame retardant. The molded body includes a plurality of first pores and a plurality of second pores. The plurality of first pores are in fluid communication from an outer surface of the molded body. The plurality of first pores and the plurality of second pores are at least partially in fluid communication with each other. The plurality of first pores include a first average pore width, the plurality of second pores include a second average pore width, and the first average pore width is greater than the second average pore width. The flame retardant is disposed within the plurality of first pores and the plurality of second pores.

In an embodiment, the first average pore width is ranged from 50 microns to 100 microns, and the second average pore width is ranged from 2 microns to 50 microns.

In an embodiment, the molded body is produced by a powder bed fusion technology.

In an embodiment, the plurality of first pores include an inner surface, the plurality of second pores include an inner surface, and a total area of the inner surface of the plurality of second pores is greater than that of the inner surface of the plurality of first pores.

In an embodiment, the molded body is formed by a polyamide 12 powder, and the polyamide 12 power includes an average particle size ranged from 10 microns to 70 microns.

In an embodiment, the molded body includes a specific surface area ranged from 0.2 m²/g to 1.0 m²/g.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a flowchart illustrating a manufacturing method of a flame-retardant three-dimension-molded object according to an embodiment of the present disclosure;

FIG. 2 shows a structural appearance of the flame-retardant three-dimension-molded object according to the embodiment of the present disclosure;

FIG. 3 is a microstructure illustrating the flame-retardant three-dimension-molded object according to the embodiment of the present disclosure; and

FIGS. 4A to 4D are microstructures illustrating the manufacturing the flame-retardant three-dimension-molded object according to the embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

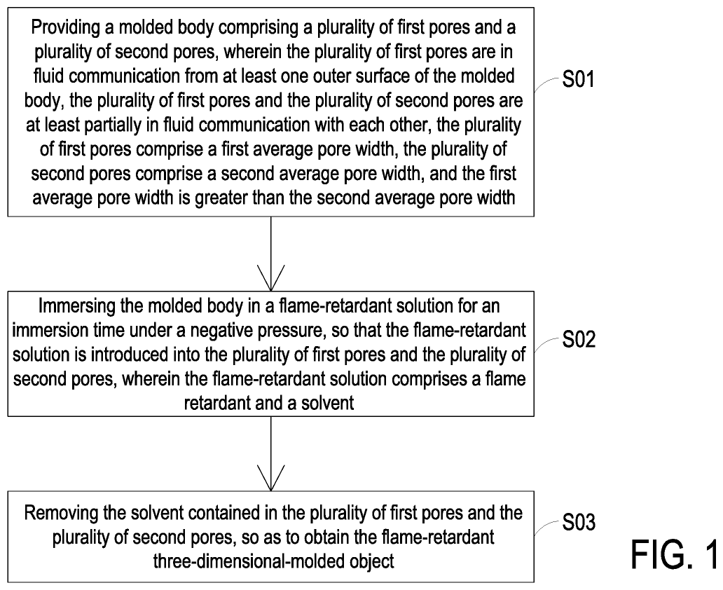

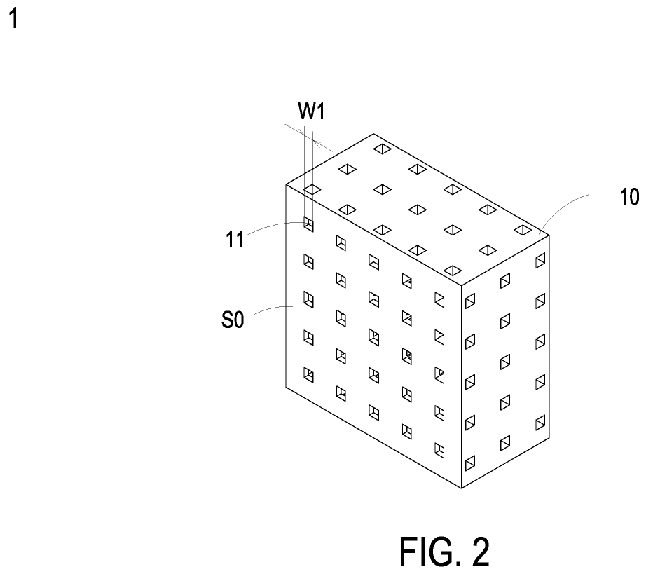

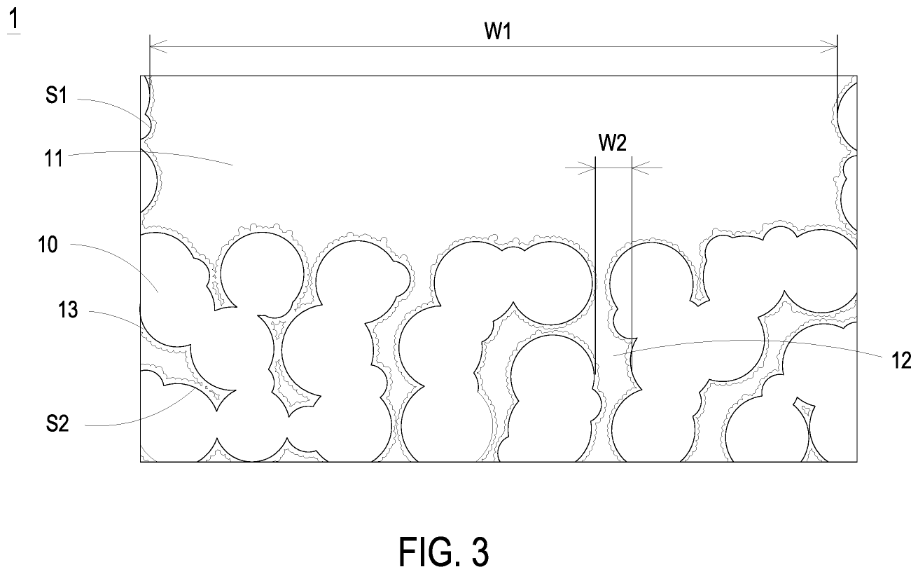

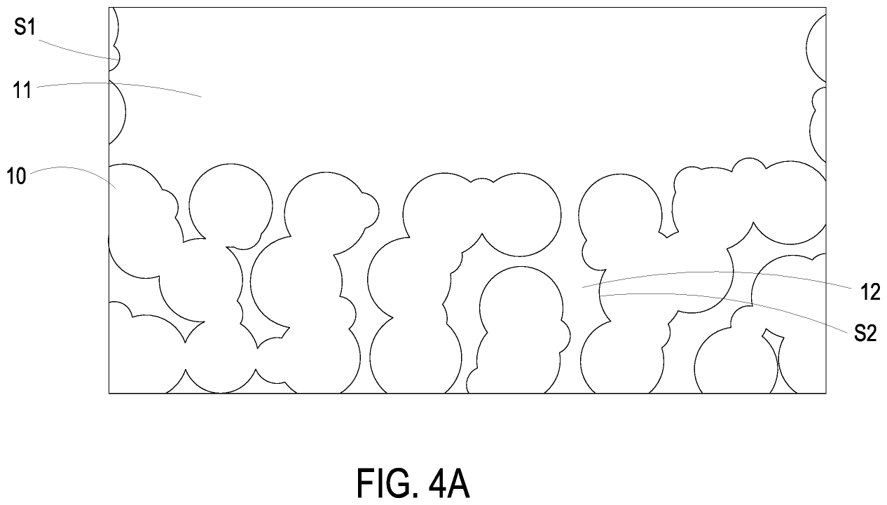

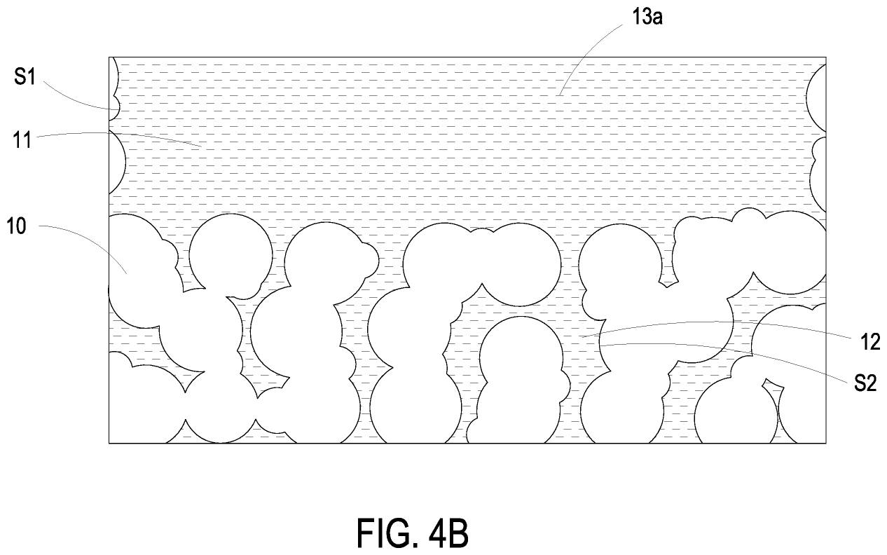

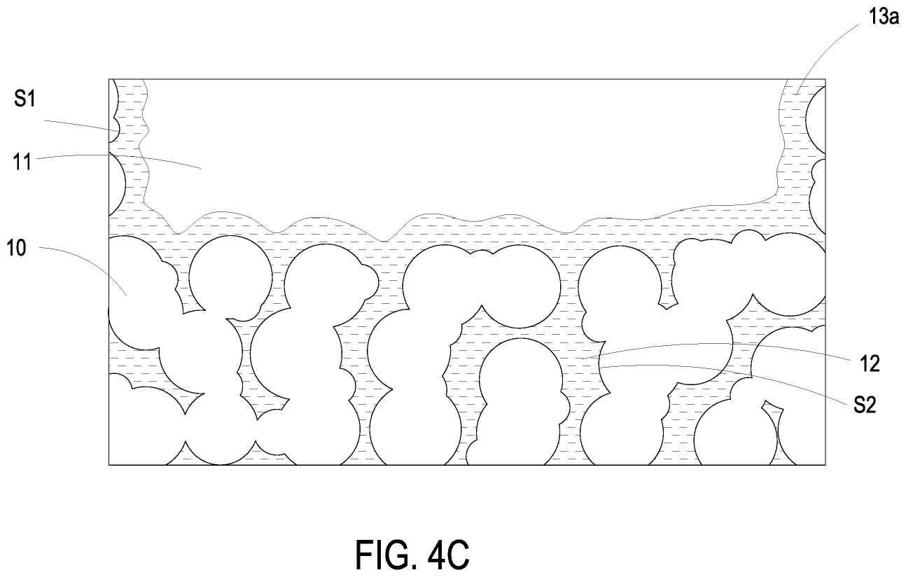

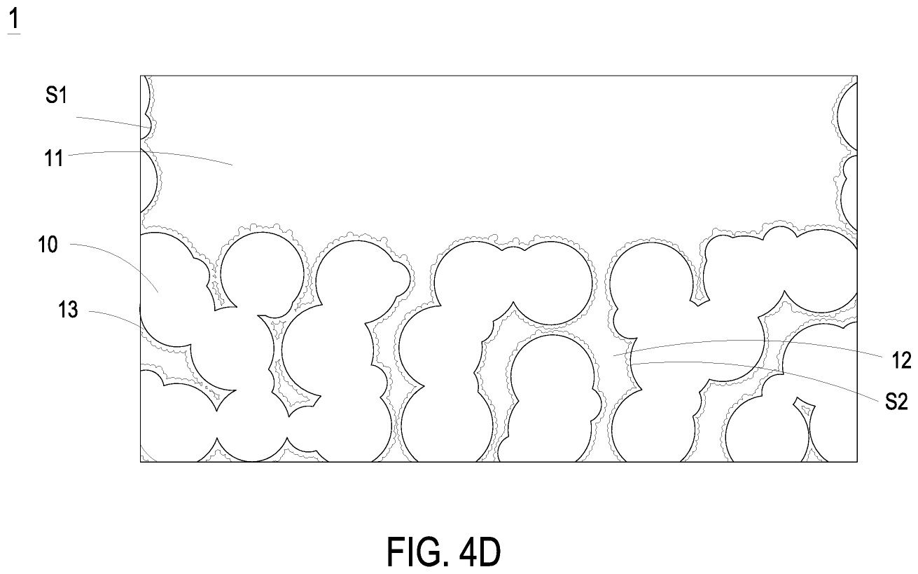

FIG. 1 is a flowchart illustrating a manufacturing method of a flame-retardant three-dimension-molded object according to an embodiment of the present disclosure. FIG. 2 shows a structural appearance of the flame-retardant three-dimension-molded object according to the embodiment of the present disclosure. FIG. 3 is a microstructure illustrating the flame-retardant three-dimension-molded object according to the embodiment of the present disclosure. FIGS. 4A to 4D are microstructures illustrating the manufacturing the flame-retardant three-dimension-molded object according to the embodiment of the present disclosure. In the embodiment, the flame-retardant three-dimensional molded object 1 is manufactured in stages. Firstly, as shown at the step S01, an additive manufacturing process, for example but not limited to a powder bed fusion (PBF) technology, is implemented to produce a molded body 10. The molded body 10 includes a plurality of first pores 11 and a plurality of second pores 12. In the embodiment, the plurality of first pores 11 are in fluid communication from at least one outer surface S0 of the molded body 10. The plurality of first pores 11 and the plurality of second pores 12 are at least partially in fluid communication with each other. The plurality of first pores 11 includes a first average pore width W 1. The plurality of second pores 12 includes a second average pore width W2. In the embodiment, the first average pore width W1 is greater than the second average pore width W2. Thereafter, as shown at the step S02, the molded body 10 is immersed in a flame-retardant solution 13a, contained in for example but not limited to a vacuum impregnation equipment, for an immersion time under a negative pressure, so that the flame-retardant solution 13a is introduced into the plurality of first pores 11 and the plurality of second pores 12. In the embodiment, the flame-retardant solution 13a includes a flame retardant 13 and a solvent (not shown). Preferably but not exclusively, the flame retardant 13 is a powdered flame retardant, which is selected from the group consisting of minerals, organohalogen compounds, organophosphorus compounds and organic compounds. Preferably but not exclusively, the solvent is an organic solvent or the water. In the embodiment, any of that capable of dissolving the flame retardant 13 to form the flame-retardant solution 13a is suitable and applicable in the disclosure. When the molded body 10 is immersed in the flame-retardant solution 13a under the negative pressure and maintained for the immersion time of ten minutes, it ensures that the flame-retardant solution 13a is introduced into the plurality of first pores 11 and the plurality of second pores 12. Preferably but not exclusively, the negative pressure is greater than 50 kilopascals (kPa) and, the immersion time is ranged from one minute to ten minutes. The plurality of first pores 11 and the plurality of second pores 12 are filled with the flame-retardant solution 13a completely. Preferably but not exclusively, the negative pressure is greater than 75 kilopascals (kPa) and the immersion time is ranged from one minute to three minutes, it ensures that the flame-retardant solution 13a is introduced into the plurality of first pores 11 and the plurality of second pores 12, as shown in FIG. 4B. After the molded body 10 immersed in the flame-retardant solution 13a is removed from the vacuum impregnation equipment, the flame-retardant solution 13a is attached to the inner surface S1 of the plurality of first pores 11 and the inner surface S2 of the plurality of second pores 12. In the embodiment, the plurality of second pores 12 are maintained and filled with the flame-retardant solution 13a completely, as shown in FIG. 4C. Finally, as shown at the step S03, after the molded body 10 is immersed to contain the flame-retardant solution 13a, the solvent contained in the plurality of first pores 11 and the plurality of second pores 12 is removed by means of for example but not limited to drying. Consequently, the flame retardant is attached to the inner surface S1 of the plurality of first pores 11 and the inner surface S2 of the plurality of second pores 12, and the flame-retardant three-dimensional molded object 1 of the present disclosure is obtained.

Notably, by using the additive manufacturing technology to stack raw materials and obtain a specific porous pattern, the molded body 10 is formed to have the porosity including the plurality of first pores 11 with the first average pore width W1 and the plurality of second pores 12 with the second average pore width W2. The molded body 10 includes a sufficient specific surface area, which is ranged from 0.2 m²/g to 1.0 m²/g. Preferably but not exclusively, the first average pore width W1 is greater than several times the second average pore width W2. In the embodiment, the first average pore width W1 and the second average pore width W2 are controlled by adjusting the size of raw materials, the sintering energy and the process parameters, and also controlled by the structural design. Preferably but not exclusively, when the molded body 10 is produced by a powder bed fusion (PBF) technology, the plurality of first pores 11 are the giant pores formed in the process, and the plurality of second pores 12 are the medium pores formed in the process. In an embodiment, the first average pore width W1 of the plurality of first pores 11 is greater than 50 microns (μm), and the second average pore width W2 of the plurality of second pores 12 is less than 50 microns (μm). Preferably but not exclusively, the first average pore width W1 of the plurality of first pores 11 is ranged from 50 (μm) microns to 100 microns (μm), and the second average pore width W2 of the plurality of second pores 12 is ranged from 2 microns (μm) to 50 microns (μm). In other embodiment, the plurality of first pores 11 of the molded body 10 further include the giant pores greater than 100 microns (μm), and the plurality of second pores 12 of the molded body 10 further include the micropores less than 2 micros (μm). The present disclosure is not limited thereto.

Taking a polyamide 12 (PA12) powder utilized in the powder bed fusion (PBF) technology as an example, the polyamide 12 includes an average particle size ranged from 10 microns (μm) to 70 microns (μm). Preferably but not exclusively, the polyamide 12 includes the average particle size of 60 microns (μm). The size of the giant pores in the molded body 10 is controlled by the structural design (i.e. the structural appearance design), and the size of the medium pores in the molded body 10 is controlled by adjusting the additive manufacturing parameters (such as the size of raw materials and the level of sintering energy). Thus, the first average pore width W1 of the plurality of first pores 11 in the molded body 10 is ranged form 50 microns (μm) to 100 microns (μm), and the second average pore width W2 of the plurality of second pores 12 in the molded body 19 is ranged from 2 microns (μm) to 50 microns (μm). In other words, with the size of the giant pores in the three-dimensional molded object 1 controlled by the structural design, and the size of the medium pores in the three-dimensional molded object 1 controlled by adjusting the manufacturing parameters, the molded body 10 of the three-dimensional molded object 1 is formed to include, for example, the giant pores as the first pores 11 and the medium pores as the second pores 12. Thus, it facilitates the flame retardant 13 of the flame-retardant solution 13a in formed of a liquid to be introduced into the plurality of first pores 11 and the plurality of second pores 12. Moreover, it also facilitates the flame retardant to be evenly distributed in the interior of the molded body 10. Consequently, the flame-retardant three-dimensional molded object 1 of the present disclosure is realized. In the embodiment, the structure of the giant pores, served as the plurality of first pores 11, is advantageous of accelerating the introduction of flame retardant solution 13a containing the flame retardant 13, and the structure of medium pores, served as the plurality of second pores 12, is advantageous of uniforming the distribution of the flame retardant 13. In the embodiment, the total area of the inner surface S2 of the plurality of second pores 12 is greater than the total area of the inner surface S1 of the plurality of first pores 11. Certainly, the number, the size and the distribution of the first pores 11 and the second pores 12 are adjustable according to the practical requirements. For example, different flame retardants 13 are utilized to add in the other embodiment, so as to meet the flammability standards in different levels. In the embodiment, by adjusting the porosity of the molded body 10, the efficiency of introducing the flame retardant 13 into the molded body 10 is improved, the manufacturing process is simplified, the flame retardancy of the three-dimensional molded object 1 is improved, and the optimized process is realized.

On the other hand, in the embodiment, the flame retardant 13 is a powdered flame retardant, which is selected from the group consisting of minerals, organohalogen compounds, organophosphorus compounds and organic compounds. Moreover, any of that capable of dissolving the flame retardant 13 to form the flame-retardant solution 13a is suitable and applicable in the disclosure. Notably, the effect of immersing the molded body 10 into the flame-retardant solution 13a is affected by the number, the size and the distribution of the first pores 11 and the second pores 12. In addition, the effect of immersing the molded body 10 into the flame-retardant solution 13a is also affected by the material of the molded body 10, which is hydrophilic or lipophilic. Certainly, the solution system is adjustable according the practical requirements, and the present disclosure is not limited thereto. In the embodiment, the molded body 10 of the three-dimension-molded object 1 is formed by the polyamide 12 (PA12) powder. Due to the hydrophilic part of the amide group is at a low proportion on the surface of the polyamide 12 polymer, the organic solvent system is preferably utilized to compose the flame-retardant solution 13a. In other embodiment, the flame-retardant solution 13a is an aqueous solution system, or a surfactant is further added to increase the compatibility of the flame-retardant solution 13a with the inner surface S1 of the first pores 11 and the inner surface S2 of the second pores 12. It is helpful of improving the immersing effect of the flame-retardant solution 13a. Certainly, the present disclosure is not limited thereto.

Referring to FIGS. 1 to 3 and FIGS. 4A to 4D. In a first exemplary embodiment, the polyamide 12 (PA12) powder is utilized to produce a test sample #1 with a thickness of 3.0 mm by the powder bed fusion (PBF) in a low sintering energy. Preferably but not exclusively, the first average pore width W1 of the plurality of first pores 11 is designed to be about 100 microns (μm). The second average pore width W2 of the plurality of second pores 12, which has high porosity due to the low sintering energy, is about 2 microns (μm). In the embodiment, the molded body 10 of the test sample #1 has a specific surface area of 0.8727 m²/g. The test sample #1 is further immersed in the flame-retardant solution 13a, which is composed of the powdered flame-retardant 13 and methyl ethyl ketone (MEK). The test sample #1 is immersed in the vacuum impregnation equipment with the flame retardant solution 13a for 5 minutes under the negative pressure, controlled at 75 kilopascals (kPa). Consequently, the flame-retardant solution 13a is introduced into the plurality of first pores 11 and the plurality of second pores 12. After the vacuum impregnation is completed, the pressure is returned. The test sample #1 containing the flame-retardant solution is dried through a drying device. In the embodiment, the test sample #1 is dried at 50° C. for 10 minutes to remove the solvent in the flame-retardant solution 13a, so that the flame retardant 13 is kept within the plurality of first pores 11 and the plurality of second pores 12. While the obtained test sample #1 is placed vertically above the flame, it stops burning within 30 seconds. The test sample #1 is classified as UL94-V2 in Standard for Safety of Flammability of Plastic Materials.

Moreover, in a second exemplary embodiment, the polyamide 12 (PA12) powder is utilized to produce a test sample #2 with a thickness of 3.0 mm by the powder bed fusion (PBF) in a high sintering energy. Preferably but not exclusively, the first average pore width W1 of the plurality of first pores 11 is designed to be about 100 microns (μm). The second average pore width W2 of the plurality of second pores 12, which has low porosity due to the high sintering energy, is about 10 microns (μm). In the embodiment, the molded body 10 of the test sample #2 has a specific surface area of 0.2947 m²/g. The test sample #2 is further immersed in the flame-retardant solution 13a, which is composed of the powdered flame-retardant 13 and methyl ethyl ketone (MEK). The test sample #2 is immersed in the vacuum impregnation equipment with the flame retardant solution 13a for 5 minutes under the negative pressure, controlled at 75 kilopascals (kPa). Consequently, the flame-retardant solution 13a is introduced into the plurality of first pores 11 and the plurality of second pores 12. After the vacuum impregnation is completed, the pressure is returned. The test sample #2 containing the flame-retardant solution is dried through a drying device. In the embodiment, the test sample #2 is dried at 50° C. for 10 minutes to remove the solvent in the flame-retardant solution 13a, so that the flame retardant 13 is kept within the plurality of first pores 11 and the plurality of second pores 12. While the obtained test sample #2 is placed vertically above the flame, it stops burning within 30 seconds. The test sample #2 is classified as UL94-V2 in Standard for Safety of Flammability of Plastic Materials.

It should be noted that the porosity formed in the additive manufacturing technology is adjustable to obtain a sufficient specific surface area, and the subsequent flame retardant 13 is effectively introduced into the pores to form the flame-retardant three-dimensional molded object 1 of the present disclosure. By adjusting the structural design, the size of raw materials, the sintering energy and the process parameters, the profile of the pores is controlled to increase the efficiency of introducing the flame retardant into the three-dimensional molded object. Moreover, the manufacturing process is simplified, and the flame retardancy of the three-dimensional molded object 1 is improved at the same time. The flame retardant 13 is not only coated on the outer surface of the molded body 10, but also evenly disposed within the plurality of first pores 11 and the plurality of second pores 12 of the molded body. The flame retardancy of the three-dimensional molded object 1 is achieved to have the effect equivalent to the product produced by using expensive flame-resistant materials. However, the material costs and the production costs of the flame-retardant three-dimensional molded object 1 are lower. Therefore, the flame-retardant three-dimensional molded object 1 of the present disclosure is more industrially competitive.

On the other hand, since the flame retardant 13 is added into the molded body 10 to form the flame-retardant three-dimension-molded object 1 after the three-dimension molding process, it prevents the flame retardant 13 from influencing the dimensional accuracy variation or the structural processing. Before the flame retardant 13 is added, the raw material used in the molded body 10 is simple, and it is conducive to the raw material recovery and reprocessing of the molded body 10. Moreover, the physical or chemical characteristics of the recovered material are not affected. When the flame-retardant solution 13a is applied and the molded body 10 formed by powder bed fusion (PBF) technology is immersed therein, the overall appearance, the materials or the original process of molding are not affected. The similar materials for the additive manufacturing are adjustable according to the practical requirements. With the manufacturing method of the present disclosure, the number, the size and the distribution of the first pores 11 and the second pores 12 or the amount of the flame retardant 13 added are adjustable to achieve different flame resistance requirements. Certainly, the type of raw material for the additive manufacturing and the type of the flame retardant 13 are adjustable. The present disclosure is not limited thereto and not redundantly described herein.

In summary, the present disclosure provides a flame-retardant three-dimension-molded object and a manufacturing method thereof. By using the additive manufacturing technology to stack raw materials and obtain a specific porous pattern, a molded body is formed and has a porosity including a plurality of first pores with a first average pore width and a plurality of second pores with a second average pore width. The molded body includes a sufficient specific surface area, and it benefits that a flame retardant is disposed within the pores of the molded body evenly in the subsequent process, for example being immersed in a flame-retardant solution. Thus, the flame-retardant three-dimension-molded object is obtained. The first average pore width of the plurality of first pores and the second average pore width of the plurality of second pores are controlled by adjusting the size of raw materials, the sintering energy and the process parameters, and also controlled by the structural design. It is helpful of increasing the efficiency of introducing the flame retardant into the three-dimensional molded object, and helpful of simplifying the manufacturing process. Consequently, the flame retardancy of three-dimensional molded object is improved. In addition, while the size of the giant pores in the three-dimensional molded object is controlled by the structural design and the size of the medium pores in the three-dimensional molded object is controlled by the process parameters of the additive manufacturing technology, the three-dimensional molded object is formed with the giant pores and medium pores. It facilitates the flame retardant in form of a liquid to be introduced into the pores. The flame retardant is evenly distributed in the interior of the three-dimensional molded objects, to achieve the manufacturing of the flame-retardant three-dimensional molded object. The structure of giant pores is helpful of introducing the flame retardant into the pores, and the structure of medium pores is helpful of uniforming the distribution of the flame retardant. Thus, the flame-retardant three-dimensional molded object of the present disclosure realizes an optimized process. On the other hand, since the flame retardant is added into the molded body after the three-dimension molding process, it prevents the flame retardant from influencing the dimensional accuracy variation or the structural processing. Moreover, it is conducive to the raw material recovery and reprocessing of the three-dimensional molded object.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A manufacturing method for a flame-retardant three-dimension-molded object, comprising steps of:
(a) providing a molded body comprising a plurality of first pores and a plurality of second pores, wherein the plurality of first pores are in fluid communication from at least one outer surface of the molded body, the plurality of first pores and the plurality of second pores are at least partially in fluid communication with each other, the plurality of first pores comprise a first average pore width, the plurality of second pores comprise a second average pore width, and the first average pore width is greater than the second average pore width;
(b) immersing the molded body in a flame-retardant solution for an immersion time under a negative pressure, so that the flame-retardant solution is introduced into the plurality of first pores and the plurality of second pores, wherein the flame-retardant solution comprises a flame retardant and a solvent; and
(c) removing the solvent contained in the plurality of first pores and the plurality of second pores, so as to obtain the flame-retardant three-dimensional-molded object.

2. The manufacturing method according to claim 1, wherein the first average pore width is ranged from 50 microns to 100 microns, and the second average pore width is ranged from 2 microns to 50 microns.

3. The manufacturing method according to claim 1, wherein the molded body is produced by a powder bed fusion technology.

4. The manufacturing method according to claim 3, wherein the plurality of first pores comprise an inner surface, the plurality of second pores comprise an inner surface, and a total area of the inner surface of the plurality of second pores is greater than that of the inner surface of the plurality of first pores.

5. The manufacturing method according to claim 3, wherein the molded body is formed by a polyamide 12 powder, and the polyamide 12 power comprises an average particle size ranged from 10 microns to 70 microns.

6. The manufacturing method according to claim 5, wherein the molded body comprises a specific surface area ranged from 0.2 m²/g to 1.0 m²/g.

7. The manufacturing method according to claim 5, wherein the negative pressure is greater than 50 kilopascals and, the immersion time is ranged from one minute to ten minutes.

8. A flame-retardant three-dimension-molded object, comprising:
a molded body comprising a plurality of first pores and a plurality of second pores, wherein the plurality of first pores are in fluid communication from an outer surface of the molded body, the plurality of first pores and the plurality of second pores are at least partially in fluid communication with each other, the plurality of first pores comprise a first average pore width, the plurality of second pores comprise a second average pore width, and the first average pore width is greater than the second average pore width; and
a flame retardant disposed within the plurality of first pores and the plurality of second pores.

9. The flame-retardant three-dimension-molded object according to claim 8, wherein the first average pore width is ranged from 50 microns to 100 microns, and the second average pore width is ranged from 2 microns to 50 microns.

10. The flame-retardant three-dimension-molded object according to claim 8, wherein the molded body is produced by a powder bed fusion technology.

11. The flame-retardant three-dimension-molded object according to claim 10, wherein the plurality of first pores comprise an inner surface, the plurality of second pores comprise an inner surface, and a total area of the inner surface of the plurality of second pores is greater than that of the inner surface of the plurality of first pores.

12. The flame-retardant three-dimension-molded object according to claim 10, wherein the molded body is formed by a polyamide 12 powder, and the polyamide 12 power comprises an average particle size ranged from 10 microns to 70 microns.

13. The flame-retardant three-dimension-molded object according to claim 12, wherein the molded body comprises a specific surface area ranged from 0.2 m²/g to 1.0 m²/g.
